(19) United States
(12) Patent Application Publication
(10) Pub. No.: US 2013/0313753 A1
(43) Pub. Date: Nov. 28, 2013

(54) ELECTRIC TERMINALS SEALED WITH MICROENCAPSULATED POLYMERS

(71) Applicant: Mark A. Scheel, Canfield, OH (US)

(72) Inventor: Mark A. Scheel, Canfield, OH (US)

(73) Assignee: DELPHI TECHNOLOGIES, INC., Troy, MI (US)

(21) Appl. No.: 13/480,898

(22) Filed: May 25, 2012

(51) Int. Cl. B29C 39/10

(52) U.S. Cl. 264/272.14

(57) ABSTRACT

A method for sealing a terminal to a hole through a plastic body includes applying a microencapsulated polymer to a portion of the terminal that is to be sealed to the hole, the microencapsulated polymer including a plurality of microcapsules where each microcapsule includes a capsule wall with reactants within the capsule wall. The method also includes surrounding the portion of the terminal with the hole after applying the microencapsulated polymer. The capsule walls are ruptured to release the reactants and seal the terminal to the hole.

### TECHNICAL FIELD OF INVENTION

The present invention relates to a method for sealing an electrical terminal to a plastic body through which the electrical terminal passes, more particularly to a method which uses microencapsulated polymers to seal the electrical terminal to the plastic body.

### BACKGROUND OF INVENTION

Electrical terminals commonly pass through plastic bodies in order to make electrical connections. For example, printed circuit boards (PCBs) are commonly disposed within a case in order to protect the circuit board from the environment. In order to make electrical connection with the PCB, one or more electrical terminals must pass through the case for connection to, for example only, a wire harness. The case may include a header which allows one or more terminals, in electrical contact with the PCB, to pass through the case.

In one example, as shown in U.S. Pat. No. 7,331,801; a circuit board is enclosed in a case and includes a plurality of electrical terminals or pins in electrical communication with the PCB. A header is provided in order to pass the plurality of electrical terminals from the interior of the case to the exterior of the case. The header is pre-formed of plastic with a plurality of holes such that each electrical terminal passes tightly through one of the holes. In order to achieve leak resistance between each terminal and its respective hole, a sealant is disposed in a cavity where each of the electrical terminals exits their respective holes. However high-precision robots and high-accuracy fluid handling systems may be needed to ensure accurate placement and amounts of the sealant. The high-precision robots and high-accuracy fluid handling systems may represent a significant capital investment. Furthermore, manufacturing time is increased due to the application and curing time of the sealant.

U.S. Pat. No. 6,964,575 shows another example of a plurality of electrical terminals passing through a header in order to exit the interior of a case. However, unlike the header of U.S. Pat. No. 7,331,801 which is pre-formed with a plurality of holes, the electrical terminals of U.S. Pat. No. 6,964,575 are insert molded into the header. More specifically, the electrical terminals are held in a desired pattern and placed at least partly within a mold and liquid plastic is injected into the mold to form the header. In this way, the header is molded around each of the terminals. While the plastic material may be molded tightly to the terminals, there may not be sufficient adhesion between the plastic and the terminals to provide sufficient sealing. An additional sealant as taught in U.S. Pat. No. 7,331,801 may need to be used to achieve the desired sealing characteristics.

U.S. Pat. No. 5,941,736 avers to seal an electrical terminal to a plastic body through which it passes without the need for a sealant as taught in U.S. Pat. No. 7,331,801. U.S. Pat. No. 5,941,736 teaches the use of microcapsules to seal the electrical terminal to the plastic body. Microcapsules containing an adhesive solution are first applied to the inside surface of a hole that passes through a pre-formed plastic body. Next, the terminal is inserted through the hole, thereby rupturing the microcapsules and releasing the adhesive solution to bond the terminal to the hole. This process, however, may be susceptible to contamination of the portion of the electrical terminal that needs to be in electrical communication with a corresponding mating terminal because the terminal must pass through the hole which contains the microcapsules. Contamination of the terminal may prevent good electrical contact between the electrical terminal that passes through the hole and its corresponding mating terminal. Furthermore, accurate application of the microcapsules to the hole of the plastic body may be difficult because the hole may be recessed within a bore of the plastic body. Additionally, this method of applying microcapsules to the inside surface of the hole is not compatible with a terminal which is insert molded into a plastic body because the hole through which the terminal passes is formed during the insert molding process.

What is needed is a method for sealing an electrical terminal to a plastic body through which the electrical terminal passes which minimizes or eliminates one or more of the shortcomings as set forth above.

### SUMMARY OF THE INVENTION

Briefly described, a method is provided for sealing a terminal to a hole through a plastic body. The method includes applying a microencapsulated polymer to a portion of the terminal that is to be sealed to the hole. The microencapsulated polymer includes a plurality of microcapsules in which each microcapsule includes a capsule wall with reactants within the capsule wall. The method also includes surrounding the portion of the terminal with the hole after applying the microencapsulated polymer. The capsule walls are ruptured to release the reactants and seal the terminal to the hole.

### BRIEF DESCRIPTION OF DRAWINGS

This invention will be further described with reference to the accompanying drawings in which:

FIG. 1 is a perspective view of a housing for accommodating a PCB and including a connection header to allow a plurality of electrical terminals in electrical contact with the PCB to pass through the housing;

FIG. 2 is an exploded perspective view of the housing of FIG. 1;

FIG. 3 is a side cross-section view of the connection header of FIG. 1;

FIG. 4 is a perspective view of a mold used to insert mold the electrical terminals with the connection header of FIG. 1;

FIG. 5 is an enlarged view of a portion of one electrical terminal of FIG. 3;

FIG. 5A is an enlarged view of a portion of the electric terminal of FIG. 3 including a microencapsulated polymer;

FIG. 5B is and enlarged view of a portion of the microencapsulated polymer of FIG. 5A;

FIG. 6 is an enlarged view of a portion of one electrical terminal and a portion of the connection header of FIG. 3;

FIG. 7 is an enlarged view of an alternative hole passing through the connection header of FIG. 3; and

FIG. 8 is a method in accordance with the present invention.

### DETAILED DESCRIPTION OF INVENTION

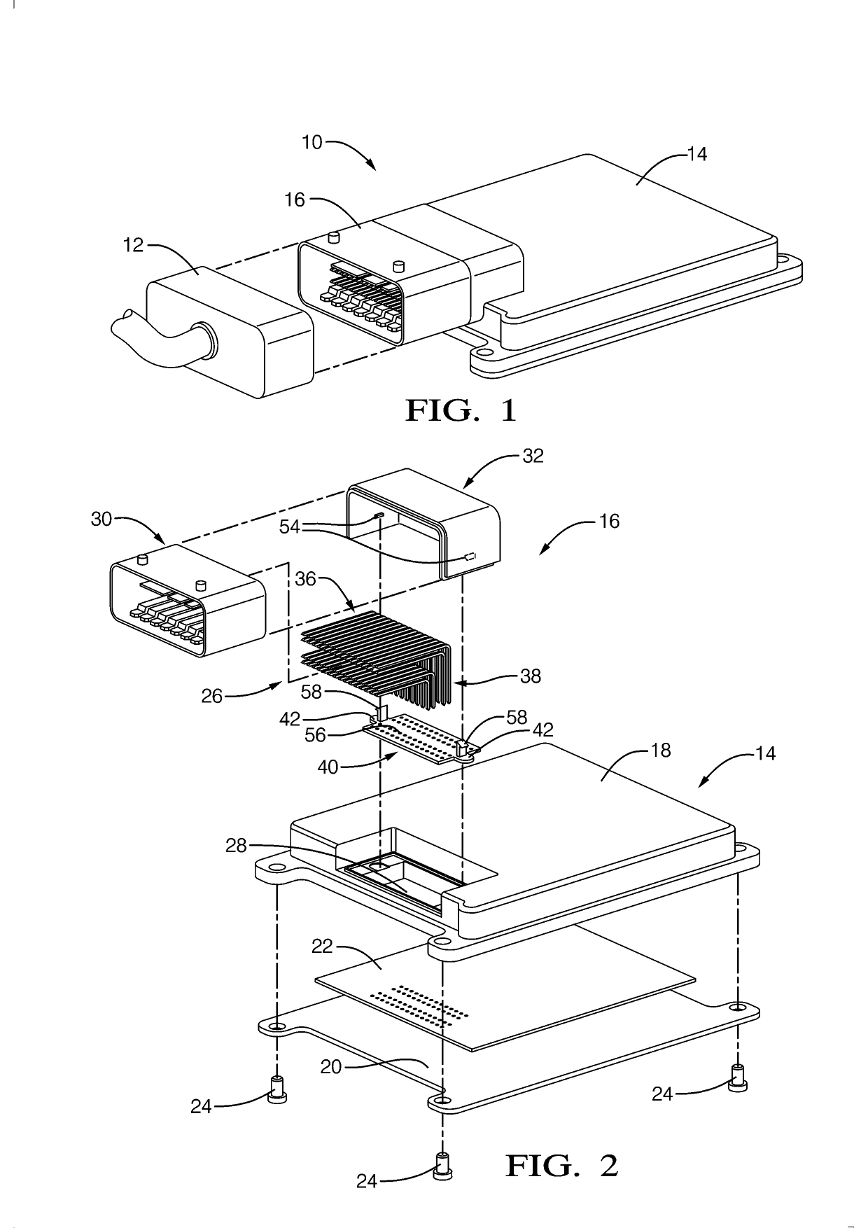

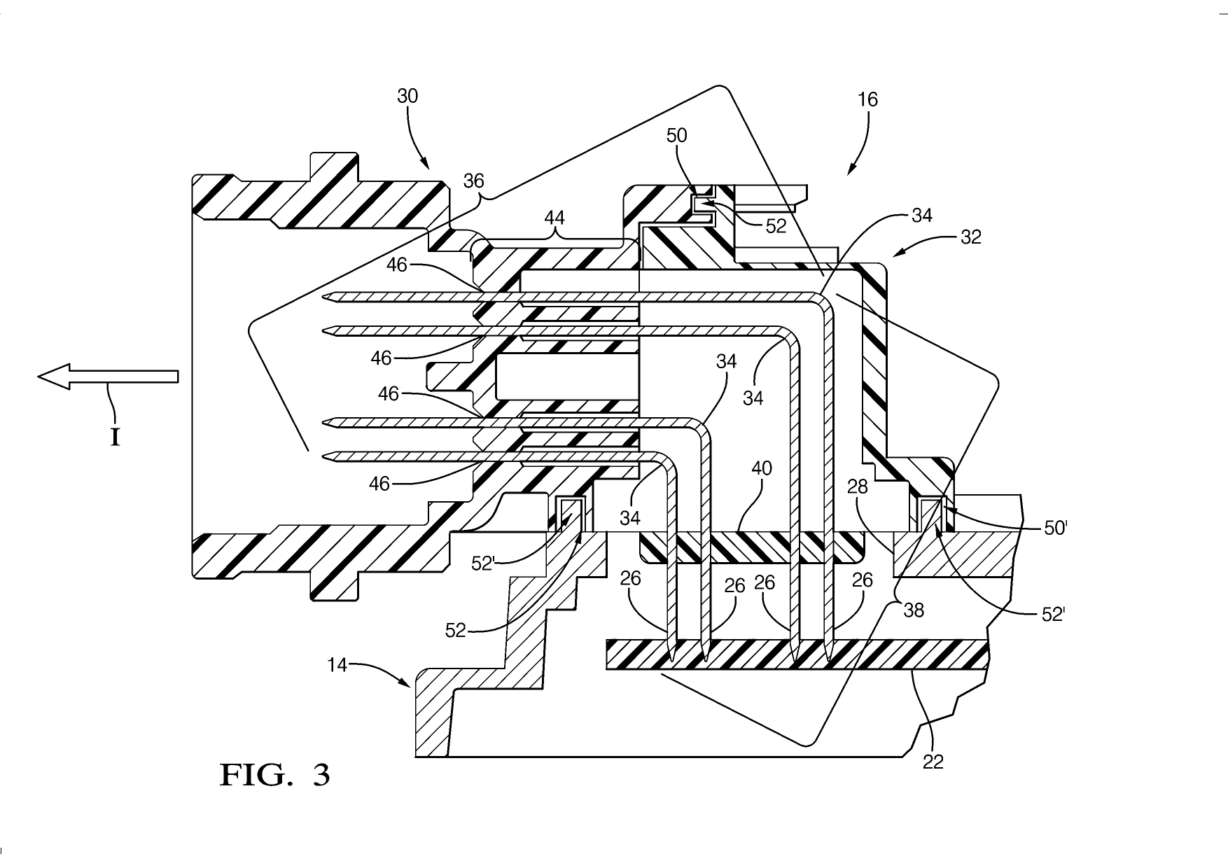

Referring now to the drawings wherein like reference numerals are used to identify identical components in the various views, FIG. 1 illustrates an exemplary plug-in connector 10 configured to receive a mating connector 12. Plug-in connector 10 generally includes a housing 14 and a header assembly 16. Now turning to FIGS. 2 and 3, housing 14 may include an upper portion 18 and a lower portion 20 that enclose a PCB 22. Lower portion 20 of housing 14 may be secured to upper portion 18 with a plurality of fasteners 24. Features may be provided within housing 14 to position PCB 22 for engagement with a plurality of electrical terminals 26 as will be further described below. Electrical terminals 26 may be configured into any size or shape, including but not limited to, circular or square. Further, any other known configuration of housing 14 may be employed. Upper portion 18 of housing 14 has an opening 28 which receives header assembly 16 and allows access to PCB 22. Header assembly 16 generally includes a connector shroud 30 that is shaped to correspond with mating connector 12. A variety of configurations of mating connector 12 may be used in conjunction with connector shroud 30 for providing a connection between plug-in connector 10 and an electrical device. Header assembly 16 further includes a hood 32 which secures to connector shroud 30 and extends beyond bend points 34 of electrical terminals 26 as will be described further below. Hood 32 thus generally conceals electrical terminals 26. When header assembly 16 is assembled, a first portion 36 of electrical terminals 26 is retained within connector shroud 30, while a second portion 38 of electrical terminals 26 is aligned by a terminal alignment guide 40. Terminal alignment guide 40 is adjacent to housing 14 and may be received by one or both of connector shroud 30 and hood 32 for engagement therewith, as will be further described below. Terminal alignment guide 40 preferably has at least one abutment feature 42 for abutting a top surface of housing 14.

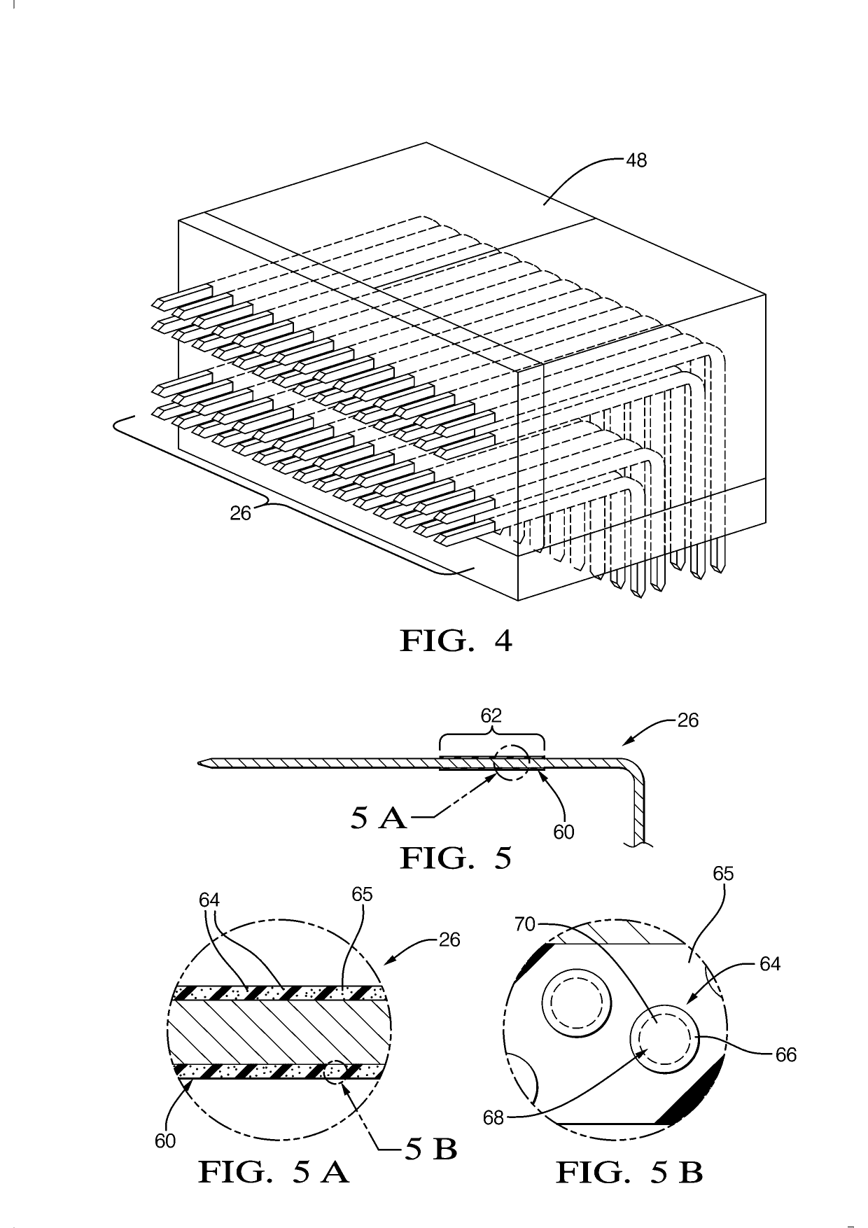

Reference will now be made to FIG. 3 which illustrates a side section view of header assembly 16 as shown in FIG. 2. Connector shroud 30 includes a terminal block 44, which generally retains four rows of electrical terminals 26. However, it should be understood that a greater or lesser number of rows of electrical terminals 26 may be employed. Terminal block 44 is made of an electrically insulative material, for example, plastic. Terminal block 44 may be integrally formed as a single piece with connector shroud 30, for example, by injection molding. Electrical terminals 26 may be formed of any known conductive material, and may be bent to form first portion 36 and second portion 38. Second portion 38 is generally orthogonal to first portion 36. Second portion 38 engages PCB 22 to provide an electrical connection with mating connector 12 through electrical terminals 26. First portion 36 is generally retained within connector shroud 30 by an interference fit between electrical terminals 26 and apertures 46 that pass through terminal block 44. Electrical terminals 26 may be disposed within terminal block 44 by linearly pushing electrical terminals 26, in the direction of arrow I, through apertures 46 that are pre-formed in terminal block 44. In this way, a portion of each electrical terminal 26 is surrounded by one respective aperture 46. In addition to the linear movement in the direction of arrow I, a rotating motion may be applied to one of terminal block 44 and electrical terminal 26. Alternatively, and referring to FIG. 4, electrical terminals 26 may be disposed within terminal block 44 by an insert molding operation where electrical terminals 26 are at least partly disposed within a mold 48 that is used to form terminal block 44. Liquid plastic is then injected into the mold 48 to simultaneously form terminal block 44 with electrical terminals 26 passing therethrough. Mold 48 may also simultaneously form connector shroud 30 as an integral, unitary piece with terminal block 44. In this way, a portion of each electrical terminal 26 is surrounded by one respective aperture 46.

Hood 32 generally protects electrical terminals 26 from damage or other interference by external objects or contaminants such as dirt, moisture, etc. Hood 32 generally extends beyond bend points 34, such that removal of hood 32 allows access to at least one row of electrical terminals 26. Hood 32 may generally be configured according to electrical terminals 26, such that hood 32 may advantageously be large enough to generally conceal electrical terminals 26 while minimizing the overall size of header assembly 16. Hood 32 may be secured to an end of connector shroud 30 adjacent to housing 14 by any method that is convenient. For example, as shown in FIG. 3, a groove 50 may be provided in connector shroud 30, which complements an extension feature or “tongue” 52 about a perimeter of hood 32. Furthermore, a sealant or adhesive may be applied about an interface between hood 32 and connector shroud 30 to prevent intrusion of moisture, dirt and other contaminants. For example, a sealant or adhesive may be applied within groove 50 of connector shroud 30. Other methods of securing hood 32 to connector shroud 30 may be employed, including, but not limited to, laser welding or ultrasonic welding. A sealed interface between hood 32 and connector shroud 30 may generally improve durability of header assembly 16 and protect electrical terminals 26 from external contaminants. Hood 32 may also include one or more detents 54 disposed on an interior surface of hood 32 (see FIG. 2) or other features for receiving a corresponding feature of terminal alignment guide 40, as will be described further below. Hood 32 may further be provided with features for engaging housing 14. For example, similar to the tongue 52/groove 50 engagement feature described for hood 32 and connector shroud 30, hood 32 may be provided with a groove 50′ which engages an extension feature or “tongue” 52′ provided in housing 14. Further, an adhesive or sealant may be disposed on either groove 50′ or tongue 52′ to further seal an interface between hood 32 and housing 14. Groove 50′ may advantageously retain excess glue or sealant when the adhesive or sealant is first disposed within groove 50′ and tongue 52′ is subsequently inserted into groove 50′, as opposed to applying adhesive or sealant to tongue 52′ first. Furthermore, any other features for securing hood 32 to housing 14 may be provided as an alternative or in addition to the tongue 52′/groove 50′ features described herein.

As shown in FIGS. 2 and 3, terminal alignment guide 40 generally improves alignment of electrical terminals 26 with respect to PCB 22. For example, a plurality of apertures 56 may be provided through terminal alignment guide 40 to surround or otherwise engage second portion 38 of each electrical terminal 26. Lateral displacement of second portion 38 of electrical terminals 26 is thereby reduced, generally preventing misalignment of electrical terminals 26 relative to an associated contact point on PCB 22. Terminal alignment guide 40 may be secured to hood 32 or connector shroud 30. For example, terminal alignment guide 40 may include lock arms 58 (see FIG. 2) extending upwards from terminal alignment guide 40 to engage detents 54 or any other corresponding feature in hood 32, thereby securing terminal alignment guide 40 to hood 32. Lock arms 58 are preferably compliant to allow deflection when terminal alignment guide 40 is inserted into hood 32 such that terminal alignment guide 40 may be moved into hood 32 until lock arms 58 engage detents 54. Further, engagement between lock arms 58 and detents 54 generally resists removal of terminal alignment guide 40 from hood 32. Other features may be provided in terminal alignment guide 40 and/or hood 32 and connector shroud 30 as an alternative to lock arms 58 for securing terminal alignment guide 40 to hood 32 and/or connector shroud 30. Abutment features 42 may prevent terminal alignment guide 40 from being displaced into opening 28 if lock arms 58 become disengaged from detents 54. Abutment features 42 preferably rest upon a top surface of housing 14, thereby preventing terminal alignment guide 40 from intruding through opening 28 toward PCB 22, and especially from contacting PCB 22.

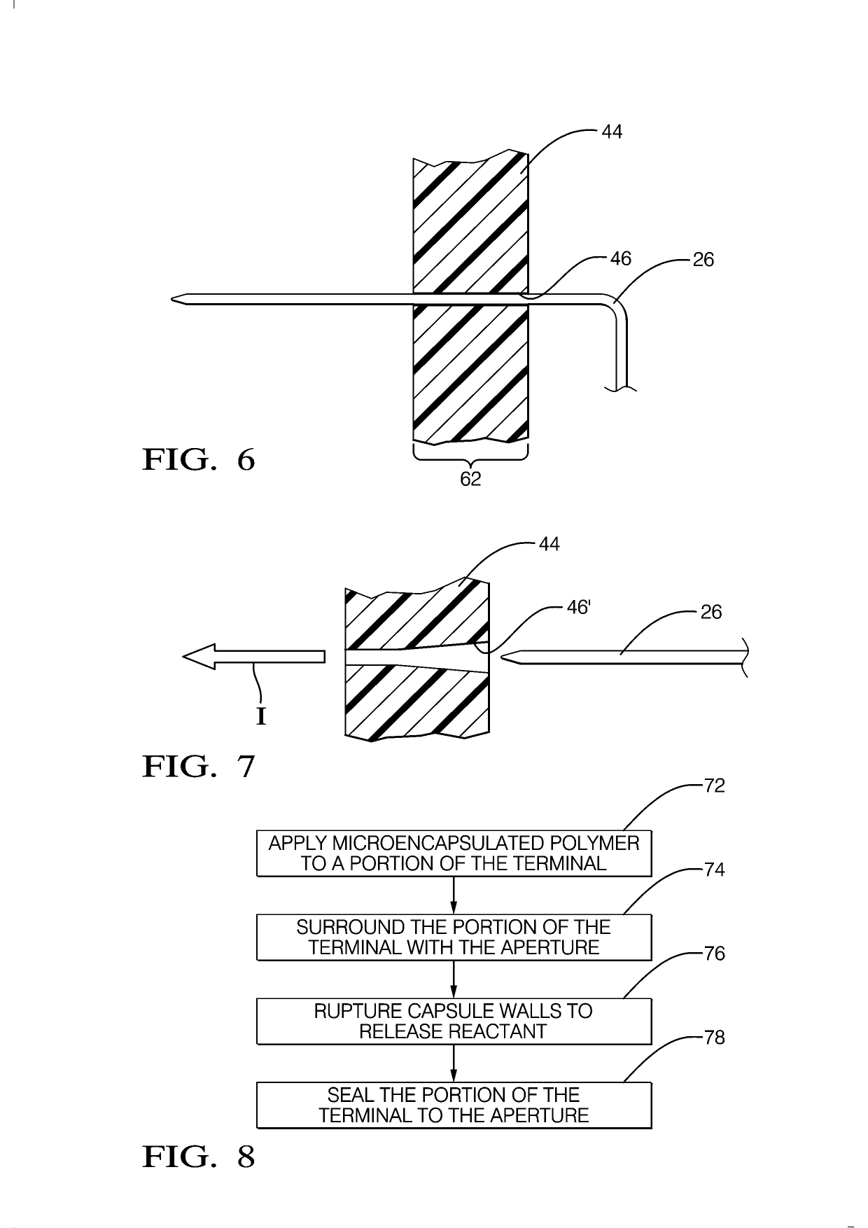

Reference will now be made to FIGS. 5, 5A, 5B, and 6 in which FIG. 5 shows a portion of one electrical terminal 26 which is representative of all electrical terminals 26, FIG. 5A shows an enlarged portion of FIG. 5, FIG. 5B shows an enlarged portion of FIG. 5B, and FIG. 6 shows the portion of electrical terminal 26 as shown in FIG. 5 now surrounded by a respective aperture 46 of terminal block 44. In order to provide a seal between electrical terminals 26 and apertures 46 of terminal block 44, a microencapsulated polymer 60 is applied to a portion 62 of electrical terminal 26 that will be surrounded by aperture 46. Microencapsulated polymer 60 is a material in which a plurality of microcapsules 64 are dispersed in a carrier resin 65. Each microcapsule 64 has a capsule wall 66 defining an interior volume 68 containing a reactant 70. In this way, capsule wall 66 segregates reactants 70 from carrier resin 65 until it is desired to mix reactants 70 with carrier resin 65 as will be described later. Microcapsules 64 may be substantially spherical and may be in the range of size from about 10 microns to about 200 microns with a typical nominal value of about 80 microns. Microencapsulated polymers are available in different chemistries including condensation-cure systems and addition-cure systems such as epoxy-amines, polyurethanes, and acrylics. Examples of commercially available products include Technik Precote®, 3M Scotch-Grip®, and ND Industries ND Microspheres®. The particular microencapsulated polymer that is chosen may depend on the performance capabilities, adhesion characteristics, and reactivity of the microencapsulated polymer in light of the desired performance and materials selected for electrical terminals 26 and terminal block 44.

In order to apply microencapsulated polymer 60 to portion 62, microencapsulated polymer 60 may be dispersed in a solvent. The mixture of the solvent and microencapsulated polymer 60 is applied to portion 62 of electrical terminal 26 prior to terminal being surrounded by aperture 46. More specifically, when electrical terminal 26 is to be inserted into aperture 46 of terminal block 44 that is pre-formed, the mixture of the solvent and microencapsulated polymer 60 is applied to portion 62 of electrical terminal 26 prior to electrical terminal 26 being inserted linearly into aperture 46. Similarly, when electrical terminal 26 is to be surrounded by aperture 46 as the result of an insert-molding operation, the mixture of the solvent and microencapsulated polymer 60 is applied to portion 62 of electrical terminal 26 prior to electrical terminal 26 being insert molded into terminal block 44. The mixture of the solvent and microencapsulated polymer 60 may be accurately applied to portion 62 of electrical terminal 26, for example, by a spraying process. After the mixture of solvent and microencapsulated polymer 60 is applied to electrical terminal 26, the solvent is allowed to evaporate, leaving only microencapsulated polymer 60 on portion 62.

When reactant 70 is released to react with carrier resin 65 and cured, electrical terminal 26 is adhered and sealed to aperture 46. In order to release reactant 70 to react with carrier resin 65, capsule wall 66 needs to be ruptured. Rupturing capsule wall 66 may be accomplished as the result of surrounding portion 62 of electrical terminal 26 with aperture 46. More specifically, when portion 62 of electrical terminal 26 is surrounded by aperture 46 as the result of subjecting electrical terminal 26 to linear motion to insert electrical terminal 26 into aperture 46 of terminal block 44 that is pre-formed, the close fit between electrical terminal 26 and aperture 46 induces a shearing action and/or compressive force on microcapsules 64, thereby causing capsule wall 66 to rupture. In addition to the linear motion used to insert electrical terminal 26 into aperture 46, a rotating motion may also be applied to either the electrical terminal 26 or the electrical terminal 26 to increase the shearing action on microcapsules 64. Similarly, when portion 62 of electrical terminal 26 is surrounded by aperture 46 as the result of an insert-molding operation, the pressure resulting from the injection of liquid plastic into mold 48 induces a shearing action and/or compressive force on microcapsules 64, thereby causing capsule wall 66 to rupture. In addition to, or in the alternative of the shearing action and/or compressive force on microcapsules 64 resulting from the insert-molding operation, heat from the insert-molding operation may act to rupture capsule wall 66. In addition to, or in the alternative of the shearing action, compressive force, and inherent heat from the processes described previously, additional heat may be added to promote the rupture of capsule wall 66. While capsule wall 66 may be ruptured due to shearing action, compressive force, or heat from surrounding electrical terminal 26 with aperture 46, capsule wall 66 is preferable sufficiently durable to withstand normal handling prior to surrounding electrical terminal 26 with aperture 46. Curing of the combination of reactants 70 and carrier resin 65 may require no additional operations, for example, the application of heat to reactants 70/carrier resin 65.

Now referring to FIG. 7, an alternative aperture 46′ passing through terminal block 44 is shown. Aperture 46′ is arranged to be tapered from a large end on the side of terminal block 44 into which electrical terminal 26 is first inserted to a small end on the opposite side of terminal block 44. More specifically, electrical terminal 26 is passed through aperture 46′ from the large diameter end to the small diameter end in the direction of Arrow I. The tapered nature of aperture 46′ may facilitate rupturing capsule walls 66.

Reference will now be made to FIGS. 3, 5, 6, and 8 where FIG. 8 shows a method of sealing electrical terminal 26 to aperture 46. In a step 72, microencapsulated polymer 60 is applied to portion 62 of electrical terminal 26 that is to be sealed with aperture 46. In a step 74, portion 62 with microencapsulated polymer 60 is surrounded by aperture 46. Capsule walls 66 of microcapsules 64 of microencapsulated polymer 60 are ruptured in a step 76 to release reactants 70 contained within capsule walls 66. It should now be understood that steps 74 and 76 may at take place at least partially simultaneously. In a step 78, reactants 70 seal electrical terminal 26 to aperture 46.

While the description thus far has been in terms of sealing electrical terminal 26 to aperture 46 of terminal block 44, it should now be understood that this method may be used in numerous arrangements where an electrically conductive element, e.g. electrical terminal 26, is to be sealed to a hole, e.g. aperture 46, of an electrically insulative body, e.g. terminal block 44.

While this invention has been described in terms of preferred embodiments thereof, it is not intended to be so limited, but rather only to the extent set forth in the claims that follow.

We claim:

1. A method for sealing an electrically conductive terminal to a hole through an electrically insulative body, said method comprising:
applying a microencapsulated polymer to a portion of said terminal that is to be sealed to said hole, said microencapsulated polymer including a plurality of microcapsules where each microcapsule includes a capsule wall with reactants within said capsule wall;
surrounding said portion of said terminal with said hole after applying said microencapsulated polymer;
rupturing said capsule wall to release said reactants; and
sealing said terminal to said hole with said reactants.

2. A method as in claim 1 further comprising the step of dispersing said microencapsulated polymer in a solvent prior to said applying step.

3. A method as in claim 2 wherein said microencapsulated polymer is applied to said portion together with said solvent.

4. A method as in claim 3 wherein said solvent is allowed to evaporate prior to said surrounding step.

5. A method as in claim 1 wherein said body and said hole through said body are pre-formed and said surrounding step includes inserting said terminal into said hole with a linear motion of said terminal relative to said hole.

6. A method as in claim 5 wherein said hole is tapered.

7. A method as in claim 5 wherein said rupturing of said capsule wall is the result of said linear motion.

8. A method as in claim 5 wherein said surrounding step includes inserting said terminal into said hole with a rotating motion.

9. A method as in claim 8 wherein said rupturing of said capsule wall is the result of at least one of said linear motion and said rotating motion.

10. A method as in claim 1 further comprising the step of forming said hole to be tapered.

11. A method as in claim 1 wherein said surrounding step includes insert molding said body around said portion of said terminal.

12. A method as in claim 11 where said rupturing of said capsule wall is the result of mechanical forces from said insert molding.

13. A method as in claim 11 wherein said rupturing of said capsule wall is the result of thermal stress from said insert molding.

14. A method as in claim 1 further comprising the step of applying heat to said microencapsulated polymer, wherein said rupturing of said capsule wall is the result at least in part of said applying heat to said microencapsulated polymer.

15. A method as in claim 1 wherein said microencapsulated polymer also includes a carrier resin within which said plurality of microcapsules are dispersed.

16. A method as in claim 15 wherein said capsule wall segregates said reactants from said carrier resin prior to said step of rupturing said capsule wall.

17. A method as in claim 15 further comprising the step of dispersing said microencapsulated polymer in a solvent prior to said applying step.

18. A method as in claim 17 wherein said microencapsulated polymer is applied to said portion together with said solvent.

19. A method as in claim 18 wherein said solvent is allowed to evaporate prior to said surrounding step.

20. A method as in claim 15 wherein said body and said hole through said body are pre-formed and said surrounding step includes inserting said terminal into said hole with a linear motion of said terminal relative to said hole.

21. A method as in claim 20 wherein said rupturing of said capsule wall is the result of said linear motion.

22. A method as in claim 15 wherein said surrounding step includes insert molding said body around said portion of said terminal.

23. A method as in claim 22 where said rupturing of said capsule wall is the result of mechanical forces from said insert molding.

24. A method as in claim 22 wherein said rupturing of said capsule wall is the result of thermal stress from said insert molding.

25. A method as in claim 15 further comprising the step of applying heat to said microencapsulated polymer, wherein said rupturing of said capsule wall is the result at least in part of said applying heat to said microencapsulated polymer.
